(19) United States
(12) Patent Application Publication
(10) Pub. No.: US 2015/0260267 A1
(43) Pub. Date: Sep. 17, 2015

(54) ANTI-JAM STRUCTURE FOR LINEAR ACTUATOR

(71) Applicant: Tricore Corporation, Changhua County (TW)

(72) Inventor: Ping-Ju HSIEH, Changhua County (TW)

(73) Assignee: Tricore Corporation, Changhua County (TW)

(21) Appl. No.: 14/204,588

(22) Filed: Mar. 11, 2014

(51) Int. Cl. F16H 25/12

(52) U.S. Cl. CPC F16H 25/12

(57) ABSTRACT

An anti-jam structure for linear actuator includes a screw nut including a screw rod passage defining an internal thread segment and a threadless segment and one or multiple elongated slots longitudinally extended from one end thereof corresponding to the threadless segment and in communication between the screw rod passage and the atmosphere, a cover member mounted on the outside of the screw nut to block the elongated slots, and a magnet holder defining therein an accommodation chamber that accommodates the screw nut and the cover member. Thus, during operation of the linear actuator, the elongated slots enable the screw nut to be elastically compressed, reducing the risk of screw rod jam due to bearing of a load or high vibrations.

### BACKGROUND OF THE INVENTION

1. Field of the Invention

The present invention relates to linear actuator technology and more particularly, to an improved structure of rotor module with anti-jam function for use in a linear actuator

2. Description of the Related Art

In contrast to the circular motion of a motor, a linear actuator uses a motor to provide linear motion, and therefore, linear actuators are widely used in all kinds of machine tools and large machinery. A typical linear actuator converts rotary motion of a motor rotor into linear displacement via a screw rod that is threaded into an inner thread in the motor rotor. However, if a conventional linear actuator bears a load or vibrations occurred in the surrounding areas during operation, the inner thread of the motor rotor can be not accurately meshed with the screw rod, causing the screw rod to get jammed and further making the linear actuator to lose its original function.

### SUMMARY OF THE INVENTION

The present invention has been accomplished under the circumstances in view. It is the main object of the present invention to provide an anti--jam structure for linear actuator, which prevent the screw rod of the linear actuator from being jammed during rotation.

To achieve this and other objects of the present invention, an anti-jam structure in accordance with the present invention is used in a linear actuator and adapted for rotating a screw rod, comprising a screw nut, a cover member and a magnet holder. The screw nut comprises a screw rod passage extending through two opposite ends thereof and defining an internal thread segment and a threadless segment, and at least one elongated slot longitudinally extended from one end thereof corresponding to the threadless segment and disposed in communication between the screw rod passage and the atmosphere. The cover member is mounted on the screw not to block the elongated slot. The magnet holder defines therein an accommodation chamber that accommodates the screw nut and the cover member.

Thus, during operation of the linear actuator, the at least one elongated slot allows the screw nut to be elastically compressed, preventing the screw rod from being jammed due to bearing of a load or high vibrations.

Preferably, the screw nut and the cover member are mounted in the accommodation chamber of the magnet holder by insert molding.

Preferably, the screw nut comprises an annular groove extending around the periphery thereof for enabling the cover member to be mounted on the outside wall of the screw nut.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a screw nut and a cover member of an anti-jam structure for linear actuator in accordance with the present invention.

FIG. 2 is a sectional assembly view of the anti-jam structure for linear actuator in accordance with the present invention.

FIG. 3 is an exploded view of a linear actuator using the anti-jam structure in accordance with the present invention.

FIG. 4 is a sectional view of the present invention, illustrating the anti-jam structure installed in the linear actuator.

### DETAILED DESCRIPTION OF THE INVENTION

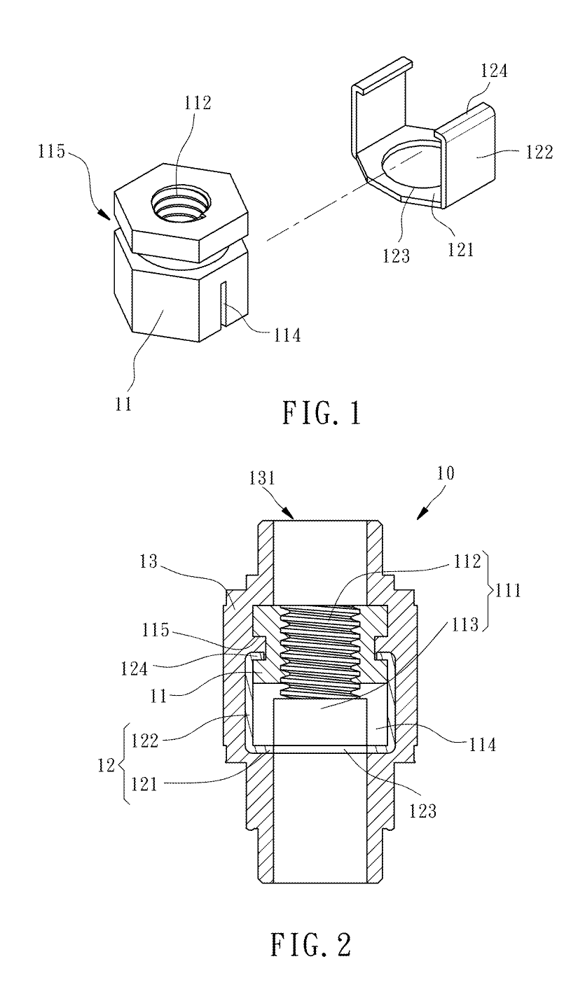

Referring to FIGS. 1-4, an anti-jam structure 10 is shown used in a linear actuator 1 that comprises a screw rod 40 that serves as an output shaft. In the following description, the projecting direction of the screw rod 40 is defined as the front side. The anti-jam structure 10 comprises a screw nut 11, a cover member 12, and a magnet holder 13, The structural features of these components and their relative relationship are described hereinafter.

Referring to FIGS. 1 and 2 again, the screw nut 11 is shaped like a hollow hexagonal cylinder, comprising an annular groove 115 extended around the periphery thereof, a screw rod passage 111 cut through opposing front and back sides thereof and defining an internal thread segment 112 and a threadless segment 113, and an elongated slot 114 longitudinally extended, from one end thereof corresponding to the threadless segment 113 and disposed in communication between the screw rod passage 111 and the atmosphere. The screw rod 40 can be threaded into the internal thread segment 112 and extended through the threadless segment 113 and rotated forwards and backwards relative to the screw nut 11 during operation of the linear actuator 1. Further, the elongated slot 114 has a length larger than the threadless segment 113, i.e., the elongated slot 114 partially enters the internal thread segment 112.

The cover member 12 is made from an elastic material and can be mounted around the outside wall of the screw nut 11 to block the elongated slot 114. In this embodiment, the cover member 12 is C-shaped, comprising a planar base portion 121, two opposing end portions 122, and a through hole 123 located at the center of the planar base portion 121. for the passing of the screw rod 40. The planar base portion 121 has two opposite ends thereof respectively connected to the end portions 122. Each end portion 122 has one end thereof connected to a respective one end of the planar base portion 121 and an opposite end thereof bent inwardly to form a hook portion 124. Thus, when the cover member 12 is attached to the outside wall of the screw nut 11 in the axial direction of the screw rod passage 111, the hook portions 124 can be hooked in the annular groove 115 and the end portions 122 can block the elongated slot 114.

The magnet holder 13 has an accommodation chamber 131 defined therein and adapted for accommodating the screw not 11 and the cover member 12 and for allowing the screw rod 40 to pass therethrough. In this embodiment, after the screw nut 11 and the cover member 12 are assembled, they are fixedly mounted in the accommodation chamber 131 of the magnet holder 13 by insert molding. Because the two end portions 122 of the cover member 12 have already blocked the elongated slot 114 prior to the insert molding, and therefore the applied molten plastic will not flow into the elongated slot 114, ensuring the elongated slot 114 can actually be effective. Further, because the elongated slot 114 has a certain length and its major part is disposed corresponding to the threadless segment 113, the elongated slot 114 provides sufficient space for enabling the screw nut 11 to be elastically compressed in case the screw rod 40 and the internal thread segment 112 are incorrectly meshed, preventing the screw rod 40 and the screw nut 11 from being stuck with each other.

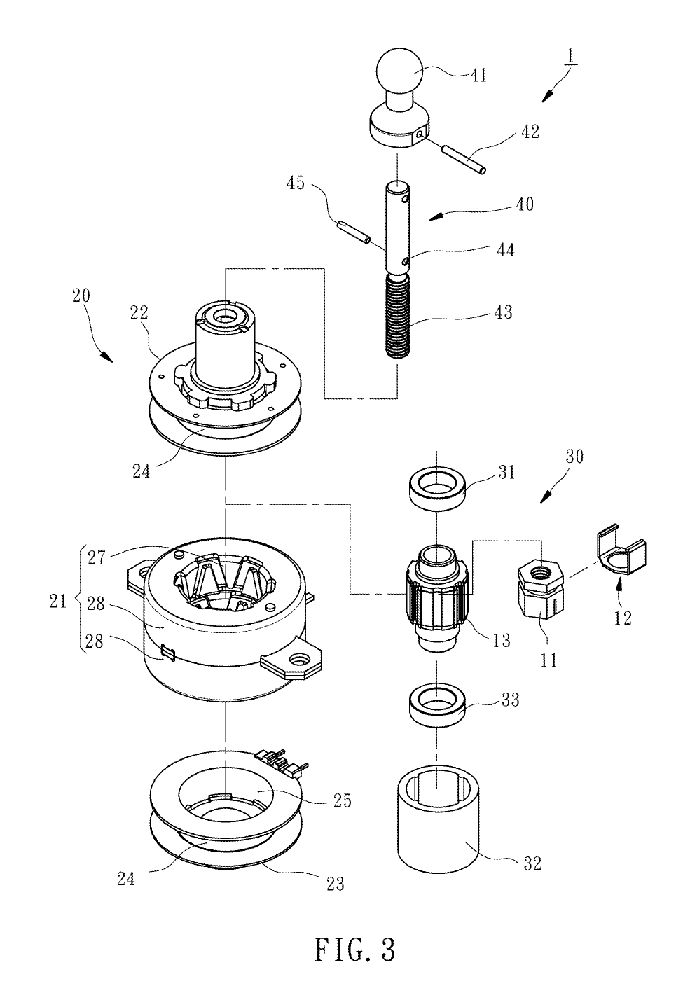

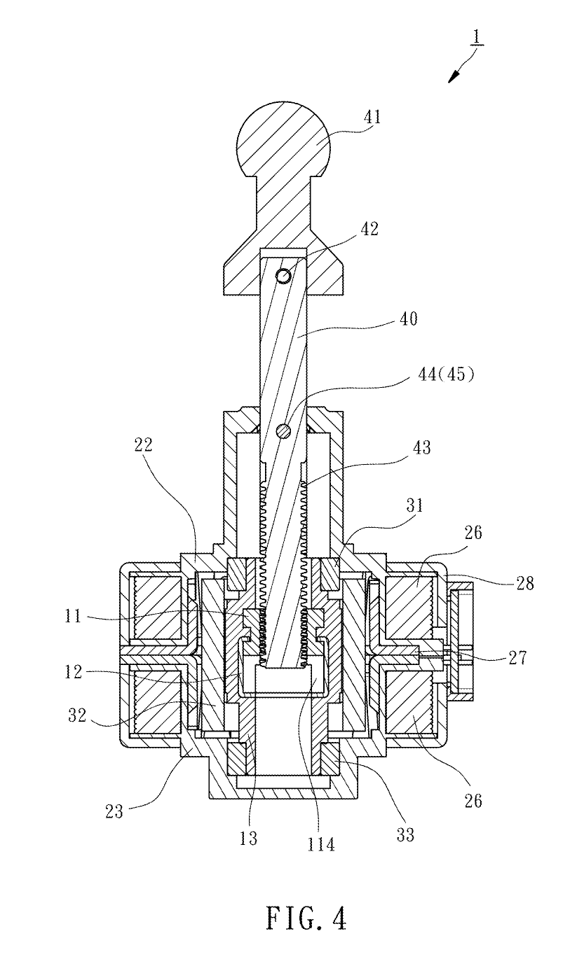

After understanding the structural details of the anti-jam structure 10 of the linear actuator 1, the other component parts of the linear actuator 1 are introduced hereinafter with reference to FIGS. 3 and 4. As illustrated, the linear actuator 1 mainly comprises a rotor module 30, a stator module 20 and the aforesaid screw rod 40.

The stator module 20 comprises a casing 21, a front cover 22 and a back cover 23. The front cover 22 and the back cover 23 are mountable in the casing 21. Further, a rotor mount 25 is set between the front cover 22 and the back cover 23 at the center. The front cover 22 and the back cover 23 each providing a mounting portion 24 for the winding of one respective coil of wire 26. In order to prevent the coil of wire 26 from being exposed to the outside and to increase the magnetic field strength, the casing 21 has an inner magnetic yoke 27 and an outer magnetic yoke 28 respectively mounted at the inner and outer perimeters thereof corresponding to the mounting portion 24 of each of the front cover 22 and the back cover 23.

Further, the magnetic holder 13 has a first axle bearing 31, an annular magnet 32 and a second bearing 33 mounted on the periphery thereof in a proper order from top to bottom. When assembled, the screw nut 11, the cover member 12, the magnet holder 13, the first axle bearing 31, the annular magnet 32 and the second axle bearing 33 constitute a rotor module 30. This rotor module 30 is mounted at the rotor mount 25.

The screw rod 40 has its one end, namely the front end connected to an external bar 41 with a lock pin 42. The periphery of the other end, namely, the rear end, of the screw rod 40 provides an outer thread 43. Thus, the rear end of screw rod 40 is threadable into the internal thread segment 112 of the screw nut 11. The screw rod 40 further comprises a pinhole 44 transversely disposed at a middle part thereof adjacent to the outer thread 43 for the mounting of a locating pin 45 to prohibit the screw rod 40 from rotation during the operation of the linear actuator 1.

When the coil of wire 26 at the back cover 23 of the stator module 20 is electrically conducted, the coil of wire 26 induces a magnetic field to drive the rotor module 30 to rotate, thereby rotating screw nut 11. At this time, the screw rod 40 has already threaded into the internal thread segment 112 of the screw nut 11 and the locating pin 45 has already mounted in the screw rod 40, therefore, during rotation of the screw nut 11, the screw rod 40 is caused to move linearly forward (or backward) subject to the rotation of the rotor module 30.

During linear displacement of the screw rod 40, the elongated slot 114 of the screw nut 11 enables the screw nut 11 to be flexibly compressed, assuring accurate mesh between the screw rod 40 and the internal thread segment 112 and preventing the screw rod 40 and the internal thread segment 112 from being stuck with each other. Therefore, even the screw rod 40 carries a load or the linear actuator 1 works under a vibration environment, the linear actuator 1 will not get stuck. Further, it is to be noted that the number of the elongated slot can be more than one, achieving the same effect of the present invention.

Although a particular embodiment of the invention as been described in detail for purposes of illustration, various modifications and enhancements may be made without departing from the spirit and scope of the invention. Accordingly, the invention is not to be limited except as by the appended claims.

What is claimed is:

1. An anti-jam structure used in a linear motor, comprising:
a screw nut comprising a screw rod passage extending through two opposite ends thereof, said screw rod passage defining an internal thread segment and a threadless segment axially aligned in line, and at least one elongated slot longitudinally extended from one end thereof corresponding to said threadless segment and disposed in communication between said screw rod passage and outside;
a cover member mounted on said screw nut to block said elongated slot; and
a magnet holder defining therein an accommodation chamber that accommodates said screw nut and said cover member.

2. The anti-jam structure as claimed in claim 1, wherein said screw nut and said cover member mounted in said accommodation chamber of said magnet holder by insert molding.

3. The anti-jam structure as claimed in claim 1, wherein said cover member is C-shaped and mounted on. the outside of said screw nut along the axial direction of said screw rod passage, comprising a planar base portion and at least one end portion connected to a border area of said planar base portion and adapted to block said at least one elongated slot.

4. The anti-jam structure as claimed in claim 3, wherein said cover member comprises a through hole located in said planar base portion.

5. The anti-jam structure as claimed in claim 3, wherein said screw nut comprises an annular groove extending around the periphery thereof; each said end portion of said cover member has one end connected to said planar base portion and an opposite end thereof inwardly curved and terminated in a hook portion adapted for hooking in said annular groove to secure said cover member to said screw nut.

6. The anti-jam structure as claimed in claim 1, wherein said screw nut is shaped like a hollow hexagonal cylinder.

7. The anti-jam structure as claimed in claim 1, wherein the number of said at least one elongated slot is 2.

8. The anti-jam structure as claimed in claim 1, wherein each said elongated slot has a length larger than said threadless segment.
